(19) United States
(12) Patent Application Publication
(10) Pub. No.: US 2010/0314021 A1
(43) Pub. Date: Dec. 16, 2010

(54) METHOD FOR THE IMPROVED MANUFACTURE OF THE INSULATION OF A CONDUCTOR ELEMENT FOR AN ELECTRICAL MACHINE

(75) Inventor: Hossein SAFARI ZADEH, Othmarsingen (CH)

Correspondence Address: Volpe and Koenig, P.C.;Dept. Alstom, 30 South 17th Street, United Plaza, Philadelphia, PA, 19103, US

(73) Assignee: ALSTOM Technology Ltd, Baden (CH)

(21) Appl. No.: 12/837,187

(22) Filed: Jul. 15, 2010

Related U.S. Application Data
(63) Continuation of application No. PCT/EP2009/050667, filed on Jan. 21, 2009.

(30) Foreign Application Priority Data
Jan. 25, 2008 (DE) 102008006056.9

(51) Int. Cl. H01B 13/08

(52) U.S. Cl. 156/51

(57) ABSTRACT

A method is provided for the manufacture of an insulation of a conductor element of an electrical machine. The insulation includes an insulating strip with a filler contained in it, which is wound around the conductor element. At least one electrode plate is arranged adjacent to the outside of the insulation, and an amount of heat being introduced into the insulation by applying a voltage between the conductor element and the electrode plate in order to cause an effect on the filler.

### CROSS REFERENCE TO RELATED APPLICATION

This application is a continuation of International Application No. PCT/EP2009/050667 filed Jan. 21, 2009, which claims priority to German Patent Application No. 10 2008 006 056.9, filed Jan. 25, 2008, the entire contents of all of which are incorporated by reference as if fully set forth.

### FIELD OF INVENTION

The present invention relates to a method for the manufacture of an insulation of a conductor element for an electrical machine, the insulation comprising an insulating strip, optionally with a filler contained in it, which is wound around the conductor element and impregnated with a curable resin.

### BACKGROUND

Conductor elements of this type are used for forming the electrical winding of large electrical machines and, in particular, for forming the stator winding of power plant generators, which usually consist of rigid metal elements. These conductor elements are of a predetermined form and are connected to one another to form the complete winding of the electrical machine. To make it possible for the conductor elements to be electrically insulated from one another, formed around the conductor elements is an insulation, which as a result of the specific forms it is given has a major influence on the loss values of the electrical machine. These loss values are determined not only by the thickness of the insulation but also by the nature of the insulation. The insulation is usually formed by an insulating strip which is wound around the conductor elements. The insulating strip is subsequently impregnated with a resin, which subsequently has to be cured. The loss values of the electrical winding, which directly influence the efficiency of the electrical machine, are also dependent on the proportion of resin that is taken up within the insulating strip. The degree of curing and, in particular, the degree of polymerization and the density of the resin in the insulating strip have an influence on the loss values.

There are many methods for the manufacture of the insulation for conductor elements that involve the so-called impregnation of the insulation formed by the insulating strip with a curable resin and the subsequent curing thereof. By introducing heat, such an effect is brought to bear on the insulation that both existing moisture is evaporated out of the insulating strip and the resin in the insulating strip itself cures. As provided by the previously known methods, these successive method steps, both for the evaporation of the moisture and for the curing of the resin, are performed in a laborious and energy-intensive way.

European patent application EP 0 978 929 A2 discloses a method for impregnating conductor elements for the stator winding of an electrical machine. For this purpose, it is provided that the conductor elements are provided over the entire length with a pressure- and fluid-tight sheath, so that the sheathed conductor bar is subjected to pressure on all sides in a pressing device. The intermediate space between the sheath and the conductor element is filled with an impregnating fluid at a pressure that is less than the pressure applied to the outside of the sheath on all sides. The conductor element with impregnating resin applied to it over its entire length and surrounded by the sheath is subsequently exposed to a curing temperature and at the same time pressed to the desired shape and size by a pressing device. This results in very energy-intensive curing of the resin within the insulating strip, since the pressing device has been heated in a conventional way. Consequently, both the conductor element and the pressing device, made up of a plurality of different pressing elements, are heated to the curing temperature. This operation is both energy-intensive and time-intensive, also often encountering problems with the achievable accuracy in terms of shape and size. Furthermore, it is also necessary to remove the conductor element from said sheath, which cannot be reused.

The stated disadvantages of the prior art give rise to the requirement for an improvement in the method of manufacturing the insulation for conductor elements that is characterized in particular by lower expenditure in terms of energy and time. Furthermore, there is the requirement for a simplified construction that particularly allows the various method steps, both of drying the insulating strip and of curing the resin with which the insulating strip is impregnated, to be simplified or combined with one another.

### SUMMARY

In a first embodiment, the present disclosure is directed to a method for the manufacture of an insulation of a conductor element for an electrical machine. The insulation includes at least one insulating strip, containing a curable resin, which is wound around the conductor element. The method includes arranging at least one electrode plate adjacent to the outside of the insulation, and applying a voltage between the conductor element and the at least one electrode plate thereby introducing an amount of heat into the insulation.

In a further embodiment, the disclosure is directed to a use of an existing mold of a pressing, impregnating and curing tool for the above method. The voltage is applied between the conductor element and the electrode plate in the form of a high voltage of 100 V to 4 kV, the voltage being set in the form of an alternating voltage with a high frequency of 50 kHz to 40 MHz. The high-frequency curing takes place while permanently applying an increased resin pressure.

### BRIEF DESCRIPTION OF THE DRAWINGS

Further measures improving the invention are described in more detail below together with the description of a schematic representation and with a preferred exemplary embodiment of the invention on the basis of the figures, in which:

FIG. 1 shows a schematic representation of a cross section of a construction comprising the conductor element, the insulation and the electrode plates;

FIG. 2 shows an exemplary embodiment of the construction as shown in FIG. 1 for a large conductor element;

FIG. 3 shows a further exemplary embodiment of the construction as shown in FIG. 1 with a small conductor element and a number of gap compensating elements;

FIG. 4 shows a further view of the electrode plates in an end region, an end cover being provided in a terminating manner;

FIG. 5 shows an exemplary embodiment of a first end cover, into which a voltage contact has been introduced, and

FIG. 6 shows a further exemplary embodiment of a second end cover with a sealable opening.

### DETAILED DESCRIPTION OF THE PREFERRED EMBODIMENTS

### Introduction to the Embodiments

It is therefore the object of the present invention to provide a method for the improved manufacture of an insulation of a conductor element for an electrical machine that avoids the disadvantages of the aforementioned prior art and has a lower expenditure in terms of energy and time.

This object is achieved on the basis of a method according to claim 1. Advantageous developments of the invention are specified in the dependent claims.

The invention includes the technical teaching that at least one electrode plate is arranged adjacent to the outside of the insulation, and an amount of heat is introduced into the insulation by applying a voltage between the conductor element and the electrode plate in order to bring an effect to bear on the resin present in the insulating strip.

The invention is based here on the idea of providing the energy for generating the curing temperature within the insulation by an electrical voltage. The arrangement of the conductor element, the insulation and the electrode plates forms a capacitor, the insulation having the properties of a dielectric as a result of liquid contained in the insulating strip or the resin contained in the insulating strip. In the first case, this may be moisture that is initially present in the insulating strip, in the second case the amount of resin that is introduced in one of the later method steps, which is cured in the insulating strip itself. If, consequently, a voltage that takes the form of a high voltage and at the same time has a high frequency is applied, an internal heat can be formed in the capacitor arrangement. The advantage is that preferably the dielectric itself heats up, and both the electrode plates and the conductor element itself are not heated, or only minimally. As a result, highly efficient introduction of energy can be achieved, particularly avoiding the disadvantage of gradient formation caused by heated tools. For if the insulation is heated by heated pressing plates, the temperature effect on the insulation adjacent to the heated elements is greater, and decreases with increasing distance from the latter. This gradient formation is not observed when the heat is generated by the high voltage with the high frequency, so that a homogeneous development of heat in the insulation can be assumed. This produces considerable advantages with respect to the full curing of the resin within the insulating strip.

According to one possible advantageous embodiment of the arrangement for implementing the manufacturing method, it is proposed that the conductor element with the insulation is placed into a first electrode plate with a U shape and is positioned centrally therein by gap compensating elements. The gap compensating elements have the task here of reducing the amount of resin for impregnating the insulation. They take up a certain amount of space within the U shape, so that the inner space of the U-shaped electrode plate can be adapted to the geometry of the conductor element. The gap compensating elements preferably comprise a nonconducting material, in particular polytetrafluoroethylene (PTFE), or a metal.

As a further measure, to close the conductor element on all sides, a planar electrode plate is positioned against the open side of the U-shaped electrode plate, while end covers formed with voltage contacts are subsequently attached to the end regions located in the direction of extent of the conductor element. This results in an arrangement comprising two electrode plates and two end covers, which form an enclosed inner space. So this inner space contains the conductor element with the insulation and gap compensating elements adjacent thereto. The end covers may be sealed in a pressure-tight manner with respect to the electrode plates by sealing elements, it being possible for a corresponding sealing element also to be provided between the U-shaped electrode plate and the planar electrode plate. By the voltage contacts in the end plates, electrical contact can be made with the conductor element, in order to apply the high voltage to it at a later time. Consequently, the voltage contacts are introduced into the end plates in such a way that they are voltage-insulated from said plates by an insulator element. As provided by the arrangement then formed, the conductor element is located within the electrode plates, the insulation still having a residual moisture as a result of the manufacturing process, and this moisture has to be removed from the insulation in the subsequent method step.

For this purpose, it is proposed that the moisture within the insulating strip is evaporated out of the insulating strip by the amount of heat introduced, while at the same time applying a vacuum in the inner space formed by the electrode plates and the end covers. In this respect, according to the invention, the amount of heat is introduced by applying the high voltage between the conductor element and the electrode plates, since the residual moisture within the insulating strip also has the properties of a dielectric. The moisture within the insulating strip is thereby heated and can evaporate. The evaporation is assisted by the formation of the negative pressure, since, with the lower pressure, the evaporation temperature of the moisture likewise falls. The coinciding application of the vacuum and introduction of the heat has the effect of further reducing the expenditure of energy for the evaporation of the moisture within the insulating strip. This drying method can be integrated into other customary methods of the prior art, for example into the so-called TVPI (Tube-Vacuum-Pressure-Impregnation) method, in which the conductor elements wound with an insulating strip are provided with a pressure- and fluid-tight sheath, which may consist of metal.

In order to impregnate the then dried insulating strip of the insulation with the resin and subsequently cure the latter, in a further method step the resin for impregnating the insulating strip is introduced through a filling opening, which is provided either in the electrode plates or in the end covers and the voltage for introducing the amount of heat is subsequently applied while continuously applying an increased resin pressure. In this method step, the resin forms the dielectric between the conductor element and the electrode plates, the introduction of heat not leading to evaporation of the resin but to curing or polymerization. The curing method can be integrated into other methods from the prior art, in particular into the TVPI method. In this method, after the residual resin has dripped off, the conductor elements wound with an insulating strip and provided with a pressure- and fluid-tight sheath, which may comprise metal, are exposed to high-frequency voltage, either as an alternative to the curing at a curing temperature or in addition thereto.

The parameters of a high voltage may be chosen differently for the evaporation of the moisture and for the curing of the resin and, for example, be varied during the respective process. The voltage is applied between the conductor element and the electrode plate in the form of a high voltage of 100 V to 4 kV, preferably of 700 V to 2 kV and particularly preferably of 1 kV. The voltage is chosen in the form of an alternating voltage with a high frequency of 50 kHz to 40 MHz, preferably of at least 0.3 MHz to 10 MHz and particularly preferably of 0.5 MHz. Depending on the consistency and type of the resin, a variation of the voltage and/or the high frequency that leads to optimization of the curing process may be chosen within the specified parameter windows. The resin preferably consists of an epoxy resin, a phenolic resin, or a polyester resin, which may optionally be additionally mixed with a catalyst before the resin is introduced into the inner space through the filling opening and impregnates the insulating strip.

To provide further curing with improved properties of the resin for the insulation with regard to the insulation values of the conductor elements, it is proposed to exchange the first end covers for the second end covers with sealable openings after the curing of the resin. In this case, the inner space is subjected to a pressure of at least 100 bar, preferably at least 300 bar, by a high-viscosity fluid, which preferably consists of oil or an asphalt, in order as a result of correspondingly adapted parameters of the high voltage to bring about further curing with at the same time increased introduction of heat and to achieve the removal of a residual amount of resin from the inner space. This extreme pressure acting together with the introduction of energy by a high-frequency alternating voltage produces an improvement in the full polymerization of the resin. Furthermore, there is no residual resin in the inner space between the electrode plates. Furthermore, an improvement in the loss values can be observed with a smaller resin content in the insulating strips, so that the performance of a generator with a winding based on conductor elements impregnated according to the invention can be improved.

The conductor element is preferably used as a component part of a stator winding and/or a rotor winding of a generator, the generator being formed in the manner of a power plant generator.

A development of the method according to the invention comprises a monitoring device, with which the progress of the curing operation and the drying operation for extracting the moisture out of the insulating strip can be monitored. For monitoring, the high voltage is switched off, the degree of drying and/or curing being determined either by a measurement of the capacitance of the capacitor formed by the conductor element, the insulation and the electrode plates or by the measurement of the energy consumption of the self-regulating high-frequency generator. In this way, monitoring of the curing operation that can be simply implemented is possible, reliable conclusions concerning the curing operation or the degree of the density of the resin within the insulating strip being determinable by a comparison with previously determined capacitance values of the capacitor.

As provided by an advantageous regime for controlling the temperature within the insulation, it is proposed that a temperature of 60° C. to 250° C., preferably of 100° C. to 180° C. and particularly preferably of 140° C., is generated in the insulation by the introduction of heat by the applied voltage. The generated temperature can, furthermore, be adapted to the type of the resin and to the desired density of the resin within the insulating strip.

In a further advantageous development of the method according to the invention, the high-frequency curing takes place while permanently applying an increased resin pressure in the existing mold of a pressing, impregnating and curing tool. Further methods from the prior art, in particular the TVPI method, can consequently be combined with the method according to the invention.

In a further particularly advantageous development of the method according to the invention, the high-frequency curing takes place while permanently applying an increased resin pressure of at least 100 bar, preferably at least 300 bar, in the existing mold of a pressing, impregnating and curing tool. Further methods from the prior art, in particular the TVPI method, can consequently be combined with the method according to the invention.

### DETAILED DESCRIPTION

Represented in FIG. 1 is the construction for implementing the method according to the invention, comprising an insulation 1 and a conductor element 2 as well as a first electrode plate 3 and a second electrode plate 4. According to the invention, a high voltage, which preferably comprises 1 kV and has a frequency of 0.5 MHz, may be applied between the electrode plates 3, 4. The insulation 1 comprises an insulating strip which is impregnated with a resin. The insulating strip is wound around the conductor element 2, which is indicated by a dashed structure of the insulation 1. The electrical contacting of the conductor element 2 takes place terminally at the end of the conductor elements, both the first electrode plate 3 and the second electrode plate 4 being contacted through the second voltage terminal. The electrode plates 3 and 4 may respectively comprise a metallic conductor and these conductors form an electrical contact with respect to one another.

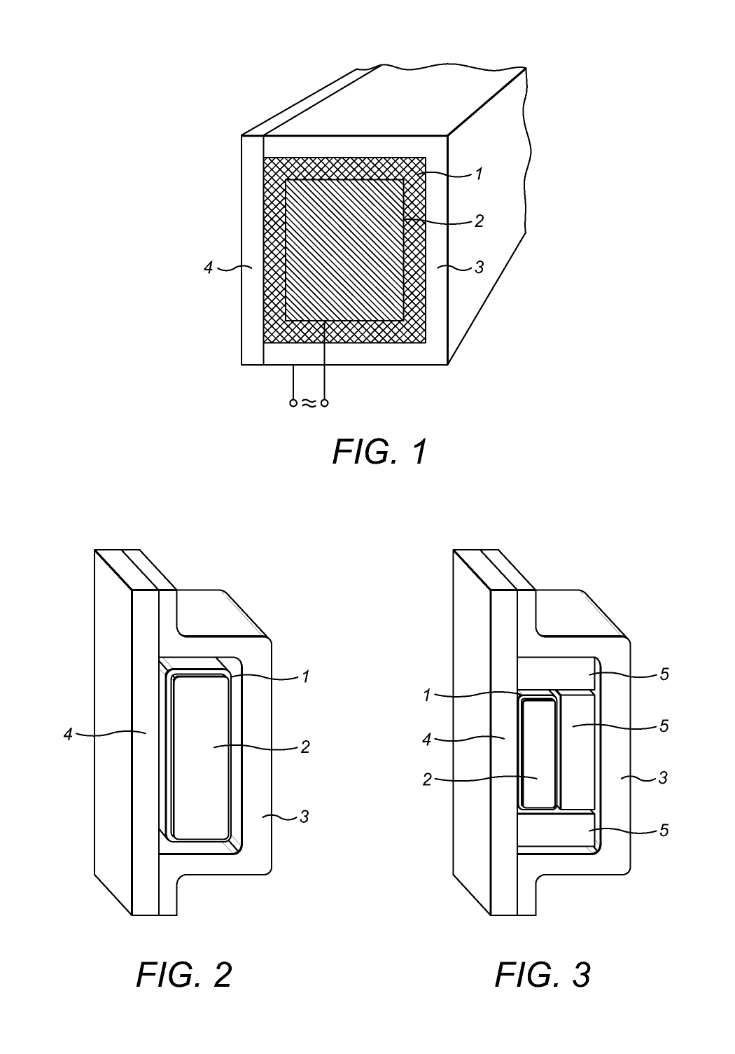

Represented in FIG. 2 is an exemplary embodiment which shows a first electrode plate 3 with a U-shaped cross section to which a planar electrode plate 4 is attached on the open side. Within the U-shaped opening is the conductor element 2, which is sheathed by way of example with an insulation 1. The size of the conductor element 2 and of the insulation 1 is adapted to the inner space of the U-shaped electrode plate 3, so that there is no gap in which excess resin can accumulate. Consequently, there is no gap between the insulation 1 and the electrode plates 3 and 4, so that the arrangement of the conductor element 2, the insulation 1 and the electrode plates 3 and 4 forms a capacitor.

Represented in FIG. 3 is a further embodiment of the arrangement as shown in FIG. 1, but the conductor element 2 having a smaller cross section than in the exemplary embodiment as shown in FIG. 2. To compensate for the gap between the conductor element 2 or the insulation 1 surrounding it and the U-shaped electrode plate 3, a number of gap compensating elements 5 are represented. The geometrical form of the gap compensating elements 5 is dimensioned together with the conductor element 2 in such a way that the inner space formed by the electrode plates 3 and 4 is completely filled. A remaining cavity for receiving the resin is merely formed by the insulating strip, which is preferably made as a strip containing mica. Pressure changes and introduced fillers or an evaporating moisture are restricted to the volume of the insulation 1, since this forms the permanent volume within the U-shaped electrode plate 3.

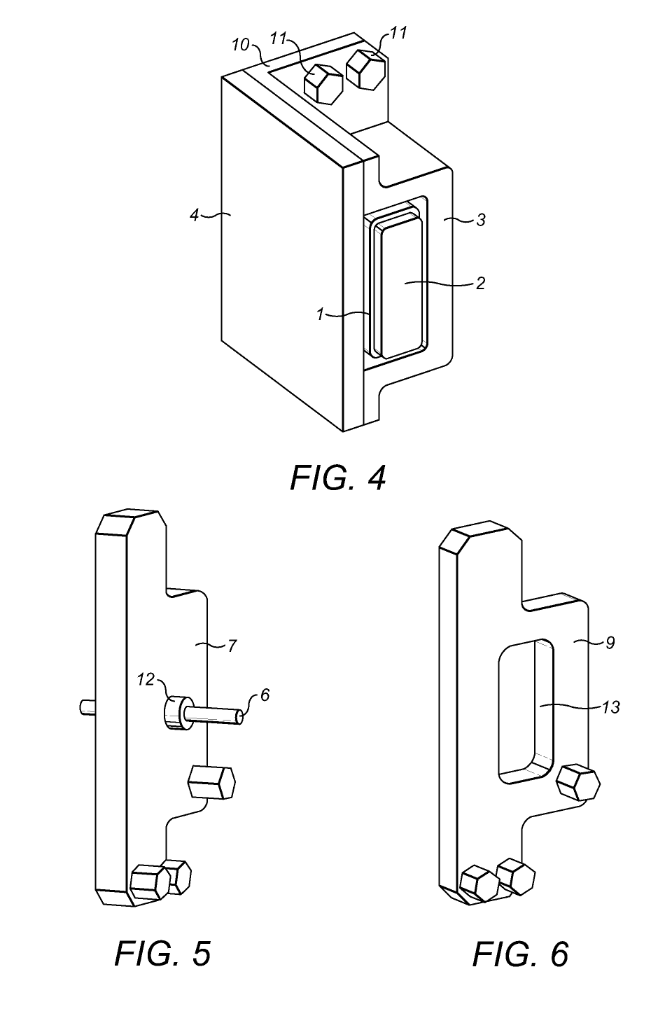

FIG. 4 shows by way of example the end region of the electrode plates 3 and 4, the electrode plate 3 having a terminating geometry 10, which can be attached to an external holding device by a screw joint 11. Furthermore, the conductor element 2 with the insulation 1 is shown on the inside between the electrode plates 3 and 4.

FIG. 5 shows by way of example a first end cover 7, which is adapted to the cross-sectional geometry that is obtained in profile by the fitted-together electrode plates 3 and 4 (see FIG. 2). In the region in which the conductor element 2 is adjacent the first end cover 7, a voltage contact 6 has been introduced and is insulated from the first end cover 7 by an insulator element 12. By way of this voltage contact 6, the conductor element can be connected to the high-voltage source in order to conduct the high voltage to the conductor element 2 and form with the electrode plates 3 and 4 the arrangement of a capacitor.

FIG. 6 shows a further exemplary embodiment of a second end cover 9, which has a sealable opening 13. The second end cover 9 is made pressure-tight in such a way that a high pressure of over 300 bar can be generated in the inner space between the electrode plates 3 and 4, in order, as provided by the last method step, to introduce a high-viscosity fluid into the inner space within the electrode plates under very high pressure and while subjecting it to increased HF energy. The full polymerization is speeded up as a result. Unnecessary heating or overheating of the electrode plates 3 and 4, as well as of the conductor element 2, can consequently be avoided, either by monitoring of the capacitance of the capacitor formed by the conductor element 2, the insulation 1 and the electrode plates 3, 4, or by self-regulation of the high-frequency generator.

The invention is not restricted to being carried out in accordance with the preferred exemplary embodiment specified above. Rather, a number of variants that make use of the solution described are conceivable, even in embodiments that are of a fundamentally different kind.

What is claimed is:

1. A method for the manufacture of an insulation (1) of a conductor element (2) for an electrical machine, the insulation (1) comprising at least one insulating strip, containing a curable resin, which is wound around the conductor element (2), the method comprising arranging at least one electrode plate (3, 4) adjacent to the outside of the insulation (1), and applying a voltage between the conductor element (2) and the at least one electrode plate (3, 4) thereby introducing an amount of heat into the insulation.

2. The method as claimed in claim 1, wherein the arrangement of a capacitor is formed by the conductor element (2), the insulation (1) and the electrode plates (3, 4), the insulation (1) having the properties of a dielectric as a result of the curable resin contained in the at least one insulating strip.

3. The method as claimed in claim 1, wherein the conductor element (2) with the insulation (1) is placed into a first electrode plate (3) with a U shape and is positioned centrally therein by gap compensating elements (5).

4. The method as claimed in claim 3, wherein the gap compensating elements (5) are adapted to contours of the electrode plates (3, 4) and of the conductor element (2) wound with the insulating strip in such a way that they completely fill a free intermediate space between them.

5. The method as claimed in claim 1 wherein, a planar electrode plate (4) is positioned against the open side of the U-shaped electrode plate (3), to close the conductor element (2) on all sides, while end covers (7) formed with voltage contacts (6) are subsequently attached to the end regions located in an extending direction of the conductor element (2).

6. The method as claimed in claim 5, wherein an amount of moisture contained in the insulating strip is evaporated out of the insulating strip by an amount of heat introduced, while at the same time applying a vacuum in an inner space formed by the electrode plates (3, 4) and the end covers (7, 9).

7. The method as claimed in claim 5, wherein a filling opening (8), through which a filler in the form of a resin for impregnating the insulating strip is introduced after drying of the insulation (1) and subsequently the voltage for introducing the amount of heat is applied, is provided in the electrode plates (3, 4) and/or in the end covers (7, 9).

8. The method as claimed in claim 1, wherein the voltage is applied between the conductor element (2) and the electrode plate (3) in the form of a high voltage of 100 V to 4 kV, the voltage being set in the form of an alternating voltage with a high frequency of 50 kHz to 40 MHz.

9. The method as claimed in claim 1, wherein the voltage is applied between the conductor element (2) and the electrode plate (3) in the form of a high voltage of 700 V to 2 kV, the voltage being set in the form of an alternating voltage with a high frequency of 0.3 MHz to 10 MHz.

10. The method as claimed in claim 1, wherein the voltage is applied between the conductor element (2) and the electrode plate (3) in the form of a high voltage of 1 kV, the voltage being set in the form of an alternating voltage with a high frequency of 0.5 MHz.

11. The method as claimed in claim 1, wherein an epoxy resin, a phenolic resin or a polyester resin is used as the resin, and wherein curing of the resin is achieved by the introduction of heat.

12. The method as claimed in claim 6, wherein first end covers (7) are exchanged for second end covers (9) with sealable openings after curing of the resin, and the inner space is subjected to a pressure of at least 100 bar, by a high-viscosity fluid, comprising an oil or an asphalt, in order to, as a result of the high voltage, bring about further curing with, at the same time, increased introduction of heat and to achieve a removal of a residual amount of resin from the inner space.

13. The method as claimed in claim 6, wherein first end covers (7) are exchanged for second end covers (9) with sealable openings after curing of the resin, and the inner space is subjected to a pressure of at least 300 bar, by a high-viscosity fluid, comprising an oil or an asphalt, in order to, as a result of high voltage, bring about further curing with, at the same time, increased introduction of heat and to achieve a removal of a residual amount of resin from the inner space.

14. The method as claimed in claim 1, wherein the conductor element (2) is used as a component part of a stator winding and/or a rotor winding of a generator, the generator being formed in the manner of a power plant generator.

15. The method as claimed in claim 8, wherein a monitoring device is provided, the degree of drying and/or curing being determined for the monitoring, with the high voltage switched off, either by a measurement of the capacitance of the capacitor formed by the conductor element (2), the insulation (1) and the electrode plates (3, 4) or by energy consumption of a self-regulating high-frequency generator.

16. The method as claimed in claim 1, wherein a temperature of 60° C. to 250° C., is generated in the insulation (1) by the introduction of heat by the applied voltage in order to achieve a polymerization of the resin.

17. The method as claimed in claim 1, wherein a temperature of 100° C. to 180° C., is generated in the insulation (1) by the introduction of heat by the applied voltage in order to achieve a polymerization of the resin.

18. The method as claimed in claim 1, wherein a temperature of 140° C., is generated in the insulation (1) by the introduction of heat by the applied voltage in order to achieve a polymerization of the resin.

19. Use of an existing mold of a pressing, impregnating and curing tool for a method for the manufacture of an insulation (1) of a conductor element (2) for an electrical machine, the insulation (1) comprising at least one insulating strip, containing a curable resin, which is wound around the conductor element (2), the method comprising arranging at least one electrode plate (3, 4) adjacent to the outside of the insulation (1), and applying a voltage between the conductor element (2) and the at least one electrode plate (3, 4) thereby introducing an amount of heat into the insulation, wherein the voltage is applied between the conductor element (2) and the electrode plate (3) in the form of a high voltage of 100 V to 4 kV, the voltage being set in the form of an alternating voltage with a high frequency of 50 kHz to 40 MHz and wherein the high-frequency curing takes place while permanently applying an increased resin pressure.

20. The use as claimed in claim 19, wherein, the permanently applied resin pressure is at least 100 bar.
